(19) United States
(12) Patent Application Publication
(10) Pub. No.: US 2001/0050658 A1
(43) Pub. Date: Dec. 13, 2001

(54) System and method for displaying online content in opposing-page magazine format

(76) Inventor: Milton Adams, New York, NY (US)

Correspondence Address: Otho B. Ross, 28th Floor, 600 Third Avenue, New York, NY, 10016, US

(21) Appl. No.: 09/878,857

(22) Filed: Jun. 11, 2001

Related U.S. Application Data
(60) Provisional application No. 60/236,198, filed on Sep. 29, 2000.
(60) Provisional application No. 60/210,947, filed on Jun. 12, 2000.

(51) Int. Cl. G09G 5/00

(52) U.S. Cl. 345/4; 345/776; 345/761

(57) ABSTRACT

This invention relates to information processing and business methods for the generation, dissemination and display of information in opposing-page magazine-type format over global communications networks such as the Internet. The invention incorporates an online magazine content development and publishing system and method, a network gateway and navigation system, and a dual-page communication appliance interface and touch screen display device. The invention is suitable for the online and offline viewing of magazine-formatted Internet Web pages and other content, online shopping, email and related uses.

### CROSS REFERENCES TO OTHER APPLICATIONS

Reference is made to prior copending U.S. provisional utility patent application number 60/236,198, filed Sep. 29, 2000, entitled “Versatile magazine system displayed in opposing-page format on multiple browsers and media-player windows,” by the inventor of the present invention. Such application is incorporated herein by reference. Reference is also made to prior copending U.S. provisional utility patent application number 60/210,947, filed Jun. 12, 2000, entitled “Integrated walk-in service for internet access and online shopping with free e-mail,” by the inventor of the present invention. Such application is incorporated herein by reference. Reference is also made to U.S. Design Pat. No. Des. 385,299, issued Oct. 21, 1997, entitled “Electronic Book”, by the inventor of the present invention. Such application is incorporated herein by reference.

### FIELD OF THE INVENTION

This invention relates to information processing and business methods for the generation, dissemination and display of information in opposing-page magazine-type format over global communications networks such as the Internet.

### BACKGROUND OF THE INVENTION

The Internet is a compelling, integrative force for global communication. Its digital environment emulates most conventional media such as the telephone, radio, and television, and has created new formats such as dynamic Web pages and email. One medium, however, that the Internet has not yet effectively captured or conveyed is the paper magazine, with its traditional and convenient opposing-page views.

Prior attempts at “electronic magazines” (variously called “e-magazines,”“e-zines,” or “zines”) include such titles as Style, Vogue IF, Feed, Salon, Slate, etc. But these vehicles generate and distribute online content in the form of columns of text and images, which the reader must scroll through vertically (and occasionally horizontally) on the reader's computer screen. In other cases, a separate Web page must be accessed and downloaded individually for each new page of content, which is time-consuming and may not work at all if a link is dead or a Web page is otherwise not operational. Thus, this method of distributing and displaying content is awkward and unnatural, and fails to convey the traditional and popular sense of magazines.

Therefore, a need exists for a familiar, flexible, convenient, fast and intuitive means of gaining access to and viewing Internet magazine and other online content.

### SUMMARY OF THE INVENTION

In view of the difficulties with the prior art, it is an object of the present invention to provide a system and method for the development, dissemination and display of magazine format information across opposing touch screens of an Internet appliance or device, and incorporating two or more Web browsers and media-player views. In one embodiment, the invention is an integrated system known as the “Versatile Internet Magazine System” (“VIMS”) system. The invention incorporates an online magazine content development and publishing system and method, a network gateway and navigation system, and a dual-page communication appliance interface and touch-screen display device. The invention is suitable for the online and offline viewing of magazine-formatted Internet Web pages and other content, online shopping, email and related uses. The invention allows a user to turn or “flip” through pre-selected Web pages at one's own rate and leisure, in a manner similar to browsing a paper magazine. The Internet device may be used either online (while logged onto the Web “live”) or in offline mode while not logged on. While online, the user may direct his or her attention to either of two pages of content since both pages are displayed simultaneously. In its offline mode, the invention dramatically improves the Internet navigation experience from “wait and see” to “touch and go.” Content of a magazine is held in a cache memory of an Internet device, and pre-loaded in multiple browser windows in a manner to accelerate its display. When flipping through magazine pages offline, the magazine provides an overview of numerous Websites in a very short time.

In one embodiment, the invention comprises a system for creating, distributing and displaying information in opposing-page magazine format, comprising:

a publishing unit for creating and distributing information over a global communication network, said information being adapted for display in opposing-page magazine format; and

an electronic display device for receiving and displaying said information, said device comprising two opposing touch-sensitive display screens, a microprocessor for operating said screens, a memory, browser software running on said microprocessor and adapted to render said information in opposing-page magazine format, and a communications device and software coupled to said microprocessor for establishing a connection to a global communications network and for receiving said information.

In another embodiment, the invention comprises a method for creating, distributing and displaying information in opposing-page magazine format, comprising the steps of:

establishing a publishing unit;

creating at said publishing unit information adapted for display in opposing-page magazine format;

distributing said information over a global communications network;

providing an electronic display device having two opposing touch-sensitive display screens and browser software adapted to display said information; and

displaying said information on said device in opposing-page magazine format.

In another embodiment, the invention comprises an electronic magazine system, comprising:

a publishing unit for creating and aggregating digital content in an opposing-page magazine format;

a diffusion unit for distributing said content over the Internet;

a display device having two display screens mounted side by side for receiving said content;

Internet Web browser software running on said device, said software being adapted to display said content in opposing-page magazine format;

a public location having Internet access to said content; and

a personal access/debit card for use in gaining access to said content.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a block diagram illustrating typical content distribution channels for magazine content for use with an embodiment of the present invention;

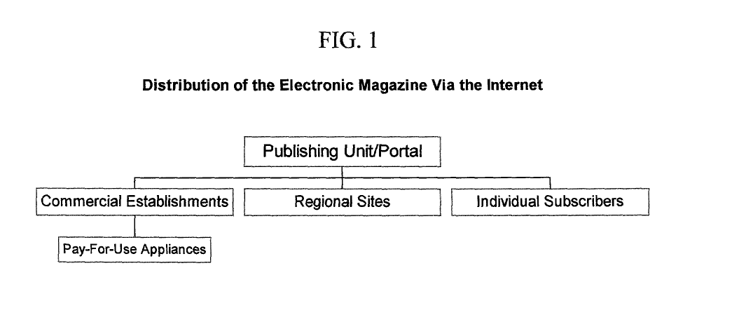

FIG. 2 is a pictorial diagram illustrating three modes of use for the invention, namely opposing-page format for magazine pages, opposing-page format for games, and laptop-type format, showing a display device rotated 90 degrees and one screen operating as a virtual keyboard; and

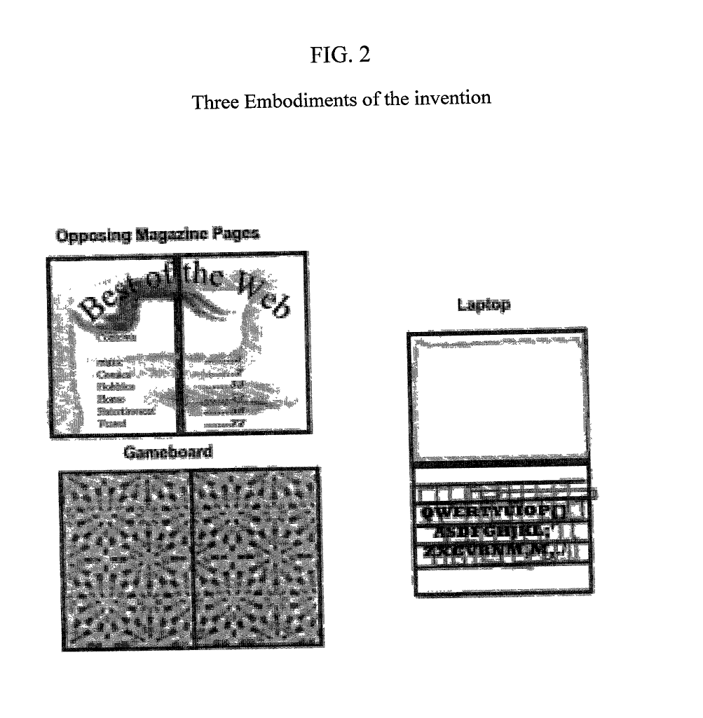

FIG. 3 is a pictorial diagram illustrating use of the invention to display two, three and four browser windows.

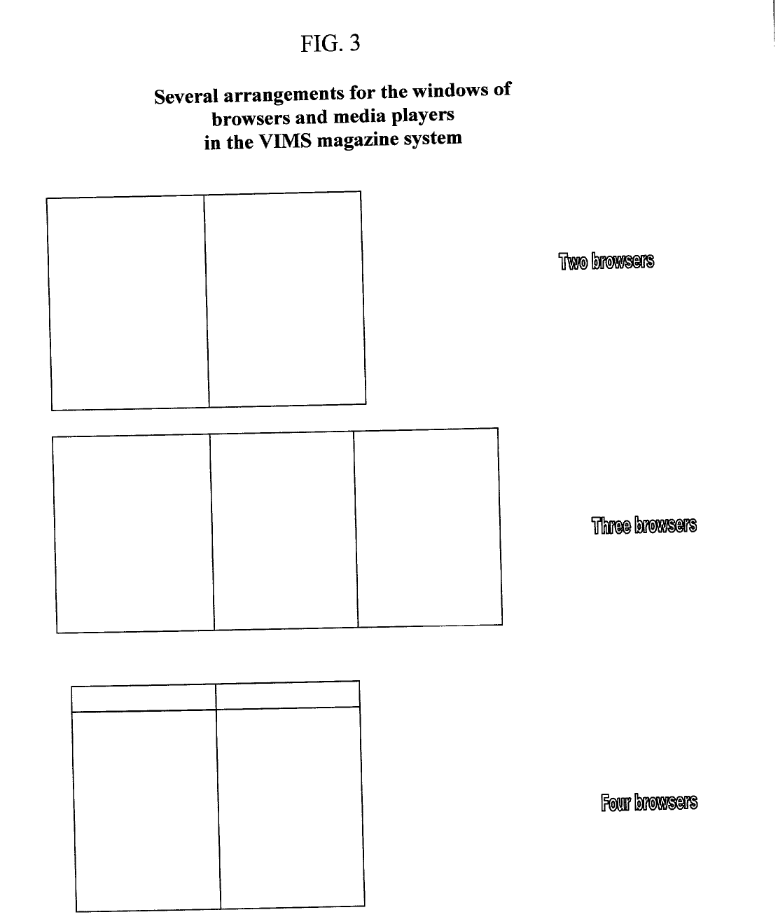

### DETAILED DESCRIPTION OF THE INVENTION

In the realm of mass media, a magazine—whether paper or electronic—is normally a periodic publication of information and opinion, expressing a consistent point of view or perspective, usually packaged as news, feature articles, reviews, interviews, advertisements, images, and the like. Dates, volumes, numbers, editions and other nomenclature distinguish its issues.

There are significant variations in the appearance of paper magazines. The elements of graphic design are applied in different ways, resulting in a world of difference, for example, between The New Yorker, and The New York Times Magazine.

Opposing Page Magazine Format.

These differences notwithstanding, one common element possessed by virtually all paper magazines is what can be called “Opposing Page Magazine Format”(“OPMF”). A conventional paper magazine is typically a hand-held paper medium whose pages are navigated with the fingers. Normally, two pages are open at all times in side-by-side (opposing page) format for ease of turning pages and scanning or reading. Textual material and images are printed on the pages. A magazine can also function as a package to bundle other media or objects inside, such as postcards, coupons, tickets, computer disks or perfume samples.

Magazines diffuse diverse forms of content (advertising, articles, editorials, interviews, poems, letters, images, etc.) on two or more opposing pages. Content is organized within text-based conceptual categories (e.g., “sports,”“people and places,”“letters to the editor,”“fashion”). An index (table of contents) is used to direct readers to content areas and specific items composed on numbered pages.

Magazines also have common compositional features that are also incorporated into the OPMF. Magazines use images, graphics, textual material, space, lines, borders, colors, and themes that bridge across opposing pages—or appear on both—to bring a sense of balance, unity and integration to the whole.

Two-Page Display.

In a feature of the invention, the traditional magazine experience is simulated on an Internet appliance or other device having a touch-sensitive electronic display panel large enough to show two legible magazine pages, side-by-side (a slate), or on a hinged device with multi-panel electronic display screens. The external appearance of preferred embodiments of the appliance are shown in U.S. Pat. No. Des. 385,299. The functionality of the appliance is described in detail below.

Page navigation is accomplished with touch controls and bezel controls on a control panel. The bezel is pre-punched as a template with a variety of see-through icon cutouts. User touch commands are transmitted through an icon, via the touch screens, to control circuitry within the device running an operating system. The icons are programmable by the user. Touch screen control is integrated with the bezel controls to eliminate the need for mechanical switches.

With the dual touch-screen displays, the end user may call up and view magazine content in a manner similar to reading a paper magazine. In addition, frames, animation, video, and other types of digital art are employed to create a magazine overlay that integrates the two screens.

In one embodiment, the opposing pages of content are displayed on the Internet appliance simultaneously using two separate microprocessors, each driving its own LCD or other standard electronic display screen and each running a stand-alone browser program such as Microsoft® Internet Explorer®, each with a connection to the Internet over a separate modem, such that each page is controllable and viewable independently. In another embodiment, the Internet appliance operates with a single microprocessor driving two screens and running an enhanced browser program, with a connection to the Internet over a modem, the browser displaying content specially pre-designed for opposing-page format display, and standard web pages. In both embodiments, an internal hard drive and battery are also provided, together with other conventional components and software found in conventional laptop personal computers and personal digital assistants.

In addition to providing dual-display support for Web browsers and readers the appliance of the invention is able to download Web pages and files to an internal cache, and employ wireless LAN protocols to interface with a server, printer, debit-card reader, and other networked devices.

In a commercial embodiment, the Internet appliance is intended for use in a public location. As such, it employs no user-accessible removable parts such as floppy disk drives, bays, memory modules or the like. It is a tethered, tabletop appliance with an external power supply. It supports a full-featured browser—such as Intern et Explorer—and associated multimedia plug-ins and applications, including reader software configured for dual screen display. Further, the displays may be personalized and customized with user-selected “skins” or graphical user interfaces (“GUIs”). In addition to operating as a magazine-type display device, the appliance may operate as a dual-screen screen game board, and a laptop computer if the appliance is rotated 90 degrees with one screen serving as a virtual keyboard.

Additional Features and Components.

In addition to the Internet appliance (which includes dual-page Web browsing software), other business method features of the invention include: (a) a publishing unit, with regional sites, that create, aggregate and diffuse (distribute) digital content in an opposing-page magazine format; (b) a stand-alone network gateway such as a Web site (or portion of a publisher's or other existing Web site) with back-end support for storing and “serving” the opposing-page formatted content; (c) Public Access Diffusion Sites (PADS), namely commercial establishments providing access to opposing-page formatted content; and, in an online shopping embodiment, (d) an access/debit card payment system for online browsing, email and purchases. These are described below.

Publishing Unit.

One feature of the invention is a publishing unit. The publishing unit is comprised of editors, writers, graphic artists, and such information technology experts as Web page designers and information systems specialists. This unit prepares, aggregates and distributes magazine content (original or otherwise) in OPMF style for diffusion and display on the Internet appliances of the invention. Activities involve writing, editing, format control, layout and maintenance of digital content. In addition, this unit encourages other Web publishers and advertisers to use this format in the design of their Web pages, and functions as an online resource center for others wishing to create or display OPMF content. Regional sites contribute and diffuse supplementary magazine content in local languages or customized to local needs. The publishing unit also administers content maintenance and update, and reformats magazine content for devices of variable screen size and number.

Content imported into magazines from third parties may be selected to survey a genre (e.g., comic strips, humor, commentary, short stories, art, etc.); present an array of national or international views on a given topic (e.g., the Olympics); survey institutional resources (museums, universities, government agencies, etc.); or for other purposes. The content is not altered; it is only displayed within the dual-browser environment of the magazine.

Magazines are distributed from the publishing unit—by wire or wireless means—to regional sites, and commercial establishments (Internet cafes, restaurants, hotels, and other public access sites) where it is cached locally or regionally on devices or servers and accessed with a subscribed pay-for-use appliance. Individuals who subscribe to a magazine for use on personal devices will access it from either the Internet publishing portal, regional sites, or commercial establishments.

Editorial Departments:

The publishing unit has four or more editorial departments/channels:

The New Economy

Lifestyles

“Best of the Internet”: A digital Readers Digest of interesting Websites.

“What's On”: A digital TV Guide of up-coming events and Web offerings

Tour Bus Tutorial.

Beyond traditional content, the Publishing Unit develops and offers new features and formats for the e-magazine, like the “Tour Bus.” While some sites today provide a path through their offerings called a “tour,” there is currently no organized tour service across Websites. The “Tour Bus” is a tutorial that provides a common Web experience to groups of users via terminal emulation, remote control navigation, ICQ, and a highlighting feature.

Chat and Highlight.

While “on the bus,” groups of users see the Web from the screen view of their tour guide. An ICQ feature allows users to chat with others who are “on the bus.” There is also a “highlight” function that allows both the guide and passengers to highlight a feature of a Web page to focus their discussions.

Real-Time and Programmed Tours.

These tours comprise real-time excursions with expert guides, and programmed tours with mediated notation and instruction. Passengers can “get off the bus” at any time to explore a site at their own pace and then rejoin the same bus, the next to come by—or a bus with a different destination.

Content Categories.

Content includes feature articles, reviews, interviews, essays, artwork, buyers' guides, advertisements and other formats typically used in paper magazines. These are displayed in a manner to optimize the aesthetic and cognitive attributes of two-page layouts, while integrating Web technologies such as Shockwave, QuickTime, Javascript and DHTML and others to render pages in a dynamic manner. Original magazine content is created, aggregated and linked across popular categories presented in a touch-and-go table of contents. These categories include, but are not limited to:

Archives

Bargains Galore

Best Web Sites

Business

Comics

Cooking ideas

Current Events

E-Books

Education

Entertainment

Fashion & Style

Guided Tours

Health/Fitness

Headlines

Hobbies

Home

Internet & Computers

Kids

Lifestyles

Love & Sex

Marriage & Family

Magazine & Newspaper Sampler

Money Matters

Media: Movies/TV/Books

Music

Personals

New Economy

People in the News

Shopping

Sports

Tutorials and Homework Help

training

Travel

Videos

Web Tours

What's On

User Operations and Controls.

The present invention simulates the experience of browsing a magazine. It presents original and imported Web pages in an opposing-page magazine format within variable arrangements of browser and media-player views—composed across two or more screens or display systems. By engaging manual control buttons on the touch-screens or the bezels, the reader flips through pages of content and advertising, accessed from fixed, removable, or networked resources. Audio effects are integrated into this feature to simulate the sound of a turning page. In the alternative, voice recognition and voice control is provided for control of content on the screens.

The invention maintains all of the functionality and features of its underlying browser platform and multimedia players. The following user controls are provided:

a) Magazine: Switches to magazine cover

b) Home: Switches to homepage

c) Flip Pages Forward

d) Flip Pages Back

e) Hold Page/Window: open future requests on another

f) Page Down

g) Page Up

h) Bookmark Page

i) Import: download content

j) GOTO Internet: Connects reader to publisher's Web portal.

k) Laptop (toggle): Shows touch-keyboard and desktop interface

l) Send Email (toggle): Switches to laptop mode and opens email program

m) Game Boards: Opens a library of board games.

n) Video

o) Switch to Landscape Orientation (toggle): Shows touch-keyboard and desktop

p) Internet browsing mode.

Opening modes.

The Internet appliance of the invention can be set to open in either “magazine mode” or to open on a designated home page stored on the device or on a network. When a device is activated in magazine mode, a magazine cover appears on the right display screen. An indicator-light blinks slowly in the upper right-hand corner of the display, or the bezel, prompting the reader to advance by touching the “Flip Pages Forward” control. By engaging the “Flip Pages Forward” control button, the reader advances through the opposing pages of the current magazine issue prepared by the publishing unit. Its pages are flipped backward with the “Flip Pages Back” control button in the upper left-hand comer of the display.

The other opening mode is home page mode. When deployed in a commercial establishment (restaurant, shopping mall, etc.) the home page is a food menu or directory stored on a server and accessed through an intranet. Home pages for personal consumer appliances and other products and services are designed by their owners and customized with links and shortcuts to favorite sites, programs, files or other functions and applications supported by the device.

Image control.

When the user double-touches a thumb-nailed image in the magazine, this action increments its size until it reaches a maximum dimension. When it is double-touched after attaining this limit, it returns to its initial size. Images used for video clips in the magazine are indicated with a “video” caption. When this type of image is touched, it activates the video to run. Touching a running video clip will cause it to pause. Double-touching a video image, increments its size to full-screen and then returns it to its original dimensions in the magazine.

Bookmarks and Buy Links. The invention is a unique system for navigating the Internet. While advancing through the electronic magazine, readers can bookmark Web pages showcased in that issue for further exploration of their sites when they are online. A tab appears along the edge of the page to indicate book-marked material. Online, the tabs can be activated by touch, connecting the reader to that particular Website. In addition, while advancing through the electronic magazine, readers can connect directly to an advertiser's e-commerce transaction site by touching a “Buy” link embedded in its ad.

The magazine acts as an Internet gateway. To go online the reader activates a “GOTO Internet” button, connecting the subscribed device of the invention to a central content portal or to a regional site.

Embedded links.

Online, when readers touch links and other interactive objects embedded in a Web page, the requested object opens in an opposing browser. When the banner ads of affiliated advertisers are touched, they open as opposing-page spreads across contiguous browser views.

Web pages that are “imported” (saved) during an online session are tabbed within the magazine for convenient offline access. Pages normally available in a browser's “History” feature can be flipped within the magazine environment.

The “Hold Page/Window” controls—located on each screen—function in both offline and online modes. When activated, they hold the content of a given browser or window, and open all further requests on another, until the button is deactivated.

The “Page Up” and “Page Down” controls function similarly to controls on conventional browsers by advancing a Web page up and down within a screen. They are used in the magazine to navigate the content of vertically oversized Web pages that cannot be perused in their entirety at a glance.

A “Laptop” switch provides support for personal communications. This control changes the appearance and orientation of the magazine to “laptop mode,” generating a functional, graphic touch-keyboard and desktop interface across the display(s). The laptop interface is used to compose email, URL addresses, Internet queries, and for other forms of keyboard communication and data entry supported by the device.

The “Send E-mail” control changes the display from magazine to laptop orientation and opens an email program.

A “Game Board” switch opens a library of board games for solo play, doubles, and multi-player games. These include an assortment of board designs for such classic games as checkers/chess, Parcheesi, Chinese checkers, backgammon, etc., and video games. These games can be activated for off-line play with opponents at a table, and for Internet play with online competitors.

The “Video” switch changes the magazine into two or more full-screen video windows that display synchronized, contiguous image views.

Internet browsing mode:

In a commercial setting, when the reader reaches the end of the magazine—or after a time interval—an indicator light blinks “GOTO Internet,” offering free Internet access for a limited time, for email or browsing, which is sponsored by magazine advertising.

Examples of Usage Modes and Environments.

The invention is useful at a variety of locations called Public Access Diffusion Sites (PADS). These include but are not limited to: Internet cafes, public reading rooms, restaurants, bars, clubs, hotels, airports, youth and senior citizen centers, “salons,” or reading rooms in private homes, housing complexes, social clubs, senior citizen centers, after-school programs, tutorials, and other public and private facilities.

Below are some examples of how the invention is used in various environments, both for magazine viewing and online shopping.

For example, in a restaurant, a client picks up a leather-bound portfolio marked “Menu,” and opens it. The restaurant's food and beverage menu is displayed across two screens of the Internet appliance of the invention in opposing-page format. The client touches a blinking control button and flips through pages of food images and menu listings (an interface).

Following simple instructions displayed on the touch-screens, or audio prompts, she selects her meal by touching desired items and confirming her choice with an “order” button located on the screen. The order is confirmed and sent to the kitchen over an Intranet (Intranet gateway). Then, the “Menu” graphic morphs into a magazine cover. The control button blinks anew, encouraging the reader to advance by touching it. She does.

The magazine opens to a Table of Contents displayed across the two browsers with topics, images and advertising. As she casually flips through the magazine, she sees articles, photos, and interviews, as in most paper magazines. There are, however, more two-page advertising spreads. In fact, most of the ads extend in landscape orientation across the two browsers (magazine/in offline mode).

In a section of the magazine called “Best of the Web” there are complete items and snippets of articles, reviews, commentary, and art that have been culled from the Web. This section is like a Reader's Digest of the Net. Several items capture her interest and she bookmarks them in the magazine. For example, there is an article from ZDNET that reviews the top portable CD players; she's been thinking of buying one. There's a snippet from an interview with her favorite tennis player at CNN Sports. There is an intriguing ad for a job search service that she decides to investigate for a young friend. For each page that is book-marked, a tab appears along the edge of the page (Internet navigation means). Now, it's time to go online.

To get online, she touches a button on the screen marked “GOTO Internet” which connects the magazine to a content portal with links to other portals (Internet gateway).

Online, she touches one of the tabs she had set and the browser connects to the Web site of the book-marked material, CNN Sports. The content is displayed within the two screens of the device. It is a long article, so she decides to save it to read later. She touches a button marked “Import.” She repeats the action for all of the tabbed items, importing them for offline reading (Internet navigation). The job search site is interesting, so she decides to send an email to her young friend recommending it.

To send email, she touches a button on the screen marked “Send email,” causing the display to change into the form of a laptop communication device. A touch-keyboard is rendered on one screen and an email program opens on the other. She adjusts the device on the table from its magazine orientation to the position in which a laptop is normally used. She composes her email message, sends it to her friend, and closes the program, causing it to change back to the magazine.

Across the aisle, at another table, two men contemplate strategic matters as they survey their position on a chessboard created by opening the device and selecting “chess” from a menu of board game options.

Across town, a physician activates his personal communication device at the breakfast table. He reviews the magazine cover, goes to the Table of Contents, touches the listing for news, and flips through a few pages of headlines and briefs. Five articles, from different sources, attract his attention, concerning new human cases of West Nile Disease and breakthroughs in immunology research. He tabs the five items and touches the “import” button, then the “GOTO Internet” button. As he prepares another cup of coffee, the magazine connects to the Internet, and imports the five complete articles into the magazine device for his review.

While reading the articles, the doctor underscores and marks some key points on one Web page, and emails it to a colleague. Soon, he is involved in a four-way Web conference with his colleague and the two authors of the immunology study who are invited to speak at an upcoming seminar.

At a nearby school, a class of twenty students talk excitedly about a trip they are about to take to Paris, without leaving their classroom—via a magazine feature called a “Tour Bus” tutorial that provides a common Web experience to groups of users. They open their magazine devices to the official Web page of the City of Paris, noting its many listed attractions. Then, the teacher takes over. As she directs her magazine browser across the various Websites for the city, the students travel with her, observing the same views in their magazine. The teacher is able to mark up pages to highlight certain idiomatic expressions for them. They use a chat feature to ask questions and exchange comments with one another.

Consumer Version.

For private consumer use, the invention is portable, with user-accessible PCMCIA-card slots under its displays. A control button in the bezel is used to access them. When pressed, the button activates a bezel release mechanism allowing the user to lift the displays away from their housing units—like butterfly wings—exposing the IC boards, PCMCIA slots, and other components.

Personalization.

With home consumer devices, the homepage setting can be configured to connect to an Internet content portal with a personalized start page (local news, entertainment, weather, transportation advisories, bargains, etc.). It can also be configured to open to a personal start page designed by the subscriber and stored on the device, or on a network. Configuration settings, user preferences, and account information are stored on a personal consumer appliance, a network server, or on an access/debit card.

Access/ Debit-Card Payment System.

Another feature of the invention is a debit-card payment system. Many individuals remain nervous about releasing credit-card data and other personal information over the Internet, due to fears of: a) credit-card fraud, b) stolen identity, and c) privacy violations. The present invention uses a system of pre-paid debit-cards at PADS to resolve these attitudinal constraints. Consumers who avoid Internet shopping at home will be more likely to do so at PADS.

In its commercial implementation, the invention serves as the interface for Internet appliances that customers rent on a pay-for-use basis in public access sites (hotels, restaurants, cafes, etc.). To use these appliances, customers obtain an access/debit-card from a dispensing machine that transfers the value of cash and bankcards to an access card. The customer may also use this card to store data about “favorite sites,” history, and configuration preferences that personalize the appearance of the magazine on any subscribed machine.

For extended Internet access—beyond an initial free period—customers obtain an access-card. Each PAD will have a debit-card dispensing machine that transfers the value of cash, bankcards, credit cards, and other forms of payment to a user access card. This card is also used to store the client's preferences, bookmarks and other desired data during Internet sessions. It can be used to personalize any machine within the invention.

For extended Internet use, the access-card of the invention is scanned at either: a) a wireless networked card reader, or b) a wired appliance. This activates pay-for-use metering software in the appliance and the server. In the former instance (a), login authorization is transmitted from the wireless card reader to a networked appliance available for use.

Advantages of the Invention

The Internet provides an entire universe of information and services that is poorly understood and sorely underutilized by much of the world's population. Even those who purchase PCs and modems limit their surfing to very few sites, oblivious to the breadth and depth of its offerings. The present invention makes the Web more accessible and useful.

As the Internet extends to serve an emerging global market of first-time users, there is a need for a familiar, flexible, and intuitive, means of harvesting its resources. The invention meets this challenge. By expanding the browser's views—and accelerating the browsing experience—the invention enhances the way people actually “see” the Internet.

An opposing-page layout has many inherent advantages over a scrollable Web page. It expands the display space for larger graphics and type fonts that improve legibility, cognition and appearance. It is particularly attractive to advertisers who can showcase their products to far greater advantage than with small banner ads. As a browser environment, it lets a user examine several Web pages simultaneously. Moreover, it is a versatile form factor for integrative appliance design. This permits readers to gain a greater sense of confidence and comfort when they view the Internet in this familiar format.

The concept of a “magazine” also connotes a “container” of useful objects or a “store” for provisions. The invention incorporates this usage as well. The invention provides subscribers with a store of useful tools and accessories that support personal communication and provide entertainment. For example, a “versatile interface module” stores and generates the invention magazine shell, as well as a laptop interface, a set of electronic game boards, and other accessories.

While the invention has been described herein with reference to certain preferred embodiments, these embodiments have been presented by way of example only, and not to limit the scope of the invention.

What is claimed is:

1. A system for creating, distributing and displaying information in opposing-page magazine format, comprising:
a publishing unit for creating and distributing information over a global communication network, said information being adapted for display in opposing-page magazine format; and
an electronic display device for receiving and displaying said information, said device comprising two opposing touch-sensitive display screens, a microprocessor for operating said screens, a memory, browser software running on said microprocessor and adapted to render said information in opposing-page magazine format, and a communications device and software coupled to said microprocessor for establishing a connection to a global communications network and for receiving said information.

2. A method for creating, distributing and displaying information in opposing-page magazine format, comprising the steps of:
establishing a publishing unit;
creating at said publishing unit information adapted for display in opposing-page magazine format;
distributing said information over a global communications network;
providing an electronic display device having two opposing touch-sensitive display screens and browser software adapted to display said information; and
displaying said information on said device in opposing-page magazine format.

3. An electronic magazine system, comprising:
a publishing unit for creating and aggregating digital content in an opposing-page magazine format;
a diffusion unit for distributing said content over the Internet;
a display device having two display screens mounted side by side for receiving said content;
Internet Web browser software running on said device, said software being adapted to display said content in opposing-page magazine format;
a public location having Internet access to said content; and a personal access/debit card for use in gaining access to said content.
